(19) United States
(12) Patent Application Publication
(10) Pub. No.: US 2008/0240163 A1
(43) Pub. Date: Oct. 2, 2008

(54) System and method for maintaining transmission synchrony

(75) Inventors: Yaser Mahmoud Ibrahim, Richardson, TX (US); Joseph Michael Erickson, Frisco, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/731,967

(22) Filed: Apr. 2, 2007

(51) Int. Cl. H04J 3/06

(52) U.S. Cl. 370/503

(57) ABSTRACT

Method for maintaining transmission synchrony in wireless communications networks. An embodiment includes computing a transmission time for a packet, adding an adjustment to the transmission time in response to a determining that clock drift has occurred between a local clock and a clock of a host device, and scheduling the packet for transmission at the transmission time. The adjustment is based on timing information provided by control instructions transmitted by the host device. The adjustment is computed using timing information from consecutively received control instructions and a single clock contained in a wireless device. If clock drift has occurred, then the timing information will differ significantly for the two control instructions. The ability to perform the clock drift calculation using a single clock may help to keep the cost and power consumption of the wireless device as low as possible.

### TECHNICAL FIELD

The present invention relates generally to a system and method for wireless communications, and more particularly to a system and method for maintaining transmission synchrony in wireless communications networks.

### BACKGROUND

Communicating wirelessly has rapidly become a popular way to exchange data and information in today's world. Wireless communications by way of radio frequency (RF), microwave, infrared, laser, and so forth, has become popular due to its lower startup costs when compared to wired communications. In a majority of cases, it may be possible to more rapidly install a wireless communications network at a lower cost than a wired communications network with a comparable performance level. The advantage may be further magnified in situations wherein a communications network is deployed in a preexisting environment, wherein the installation of a wired communications network may require extensive demolition and reconstruction work.

Another advantage of wireless communications is the greater flexibility afforded to users. A user wirelessly connected may typically have the ability to move to any position desired without concern for finding a suitable wired connection or moving a wired connection, as long as the user remains within the coverage range of the wireless communications network. For example, a user of a wireless communications network may position a personal computer in any position inside and outside of the user's residence and have a high probability of obtaining good performance. Furthermore, wirelessly connected peripherals may be placed at various locations based on convenience rather than availability of wired connections.

However, since devices operating in a wireless communications network typically operate independent of other devices, it may be difficult for the devices to maintain synchrony with one another. In a small area network, where propagation delay due to reflection, multipath, and so forth, does not pose a significant problem to maintaining synchrony, differences in clock reference frequencies may be a major cause in a drifting apart of clocks of wireless devices. With clock drift, a difference may exist in clocks of devices and the difference may continue to increase as time elapses. For example, two devices in a wireless communications network may need to maintain synchrony to ensure that their transmissions do not interfere with the transmissions of other devices. Clock drift may cause a first device to transmit at a time when the first device thought that it was clear to transmit, but due to differences in clocks, a second device may also be transmitting since its clock told the second device that it was clear to transmit.

A prior art technique to help maintain synchrony is to use a high-precision timer that is dedicated to maintaining synchrony. Then, whenever a transmission containing a transmission time is received from a transmitter, the high-precision timer is loaded with the time of the transmission and the high-precision timer may be used to maintain synchrony. However, for low cost and low power devices, the added expense (increased cost and power consumption) of the high-precision timer may significantly and negatively affect the overall cost of the device.

### SUMMARY OF THE INVENTION

These and other problems are generally solved or circumvented, and technical advantages are generally achieved, by embodiments of a system and a method for maintaining transmission synchrony in a wireless communications network.

In accordance with an embodiment, a method for determining an adjustment for clock drift is provided. The method includes receiving a first transmission with a first time stamp, receiving a second transmission with a second time stamp, and computing the adjustment based on a first receive time of the first transmission and the first time stamp, and a second receive time of the second transmission and the second time stamp.

In accordance with another embodiment, a method for transmitting a packet at a scheduled time to a host device is provided. The method includes computing a transmission time for the packet, adding an adjustment to the transmission time in response to a determining that clock drift has occurred between a local clock and a clock of the host device, wherein the adjustment is based on timing information provided by control instructions transmitted by the host device, and scheduling the packet for transmission at the transmission time.

In accordance with another embodiment, a device is provided. The device includes an amplifier coupled to an antenna, a radio frequency (RF) circuit coupled to the amplifier, a modem coupled to the RF circuit, a clock to provide a timing base for the device, and a controller configured to regulate the operation of the device and to perform computations. The amplifier alters a signal level of a signal received by the antenna, the RF circuit extracts an analog signal from a carrier signal and converts the analog signal into a digital data stream, the modem demodulates data received by the device, and the controller includes a clock adjustment unit that computes an adjustment for the clock based on timing information received in sequentially received control transmissions.

An advantage of an embodiment is that no additional hardware is required. Therefore, the cost of the communications device is not affected. Additionally, since no new hardware is required, it may be possible to add the embodiment's functionality to existing communications devices with an upgrade to controlling software. Therefore, it may help to accelerate acceptance of the embodiment.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a wireless communications network;

FIGS. 2a and 2b are diagrams of a superframe frame structure and periodic beacons transmitted within a beacon period;

FIG. 3 is a diagram of an exemplary wireless device;

FIGS. 4a and 4b are diagrams of algorithms for computing a drift adjustment; and

FIG. 5 is a diagram of an algorithm for scheduling transmission times of packets.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a wireless communications device operating in a wireless personal area network operating with several communications protocols, where the wireless communications device periodically transmits a packet to a host device. The periodic transmissions are as directed by the host device. The invention may also be applied, however, to other wireless communications devices wherein one device transmits to another device at scheduled times and where clock drift may become a problem.

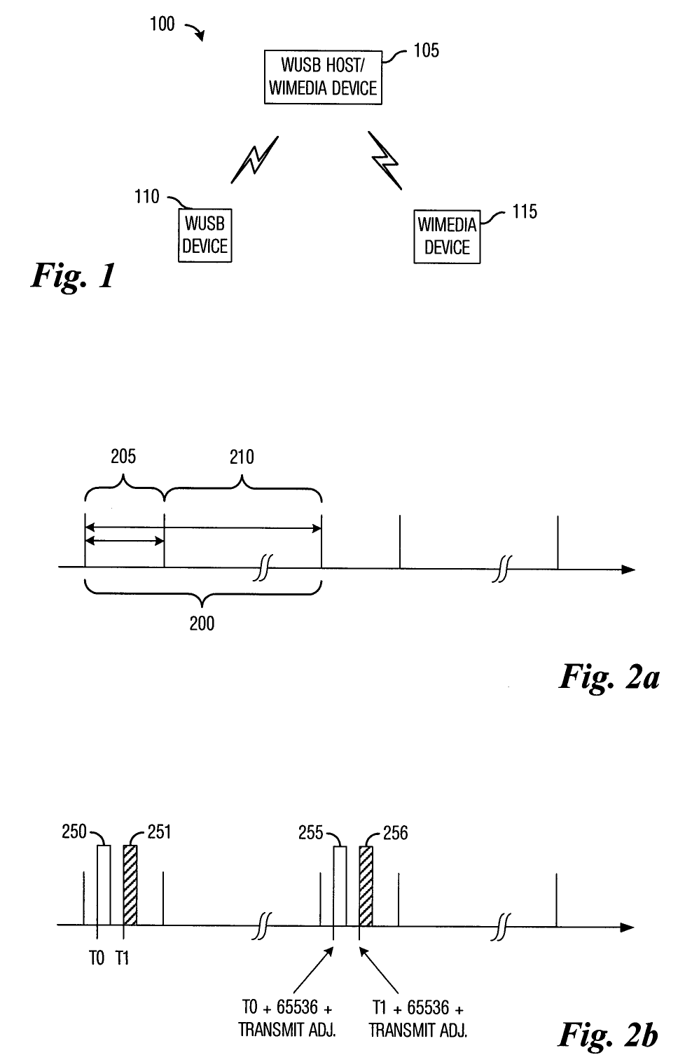

With reference now to FIG. 1, there is shown a diagram illustrating a wireless communications network 100. The wireless communications network 100 includes three wireless devices, one of which is a WUSB device 110 and another that is a WUSB host (and WiMedia device) 105. Also included in the wireless communications network 100 is a WiMedia device 115. The wireless communications network 100 may communicate using two communications protocols, a first communications protocol being wireless USB (WUSB) and a second communications protocol being WiMedia. WUSB may be used as a short range (personal area network) replacement for USB devices connected by wires and WiMedia provides multimedia connectivity and interoperability between devices in a personal area network. The WUSB protocol may operate on top of the WiMedia MAC protocol.

The WUSB host 105 may be able to communicate using both communications protocols. For example, the WUSB host 105 may communicate to the WUSB device 110 using the WUSB communications protocol and the WiMedia device 115 using another communications protocol. In order to support communications using more than one communications protocol, steps must be taken to help prevent transmissions in a first communications protocol from interfering with transmissions in a second communications protocol. For example, in a wireless communications network supporting both WUSB and WiMedia, one step that may be taken to help reduce interference involves placing WUSB devices, such as the WUSB wireless device 110 into a directed beacon mode. Detailed descriptions of the directed beacon mode may be found in a document entitled “Wireless Universal Serial Bus Specification,” Revision 1.0, published May 12, 2005, Sections 4.3.1, 4.3.4, and 4.3.7.2, and a document entitled “Distributed Medium Access Control (MAC) for Wireless Networks,” Release 1.0, published Dec. 8, 2005, Sections 8.2, and 8.5, which are hereby incorporated herein by reference.

Directed beacon mode allows WUSB wireless devices to communicate with other WiMedia devices without needing knowledge of WiMedia MAC beaconing protocol. This may help to maintain simplicity of the WUSB wireless devices. When placed into the directed beacon mode, a WUSB wireless device, such as the WUSB wireless device 110, may communicate to a host, such as the host 105, while the WUSB wireless device 110 is instructed to periodically transmit a beacon to all other WiMedia devices that may be within range. According to the WUSB technical specifications, the WUSB wireless device 110 is to transmit a first beacon at a time specified by the host 105 and then repeatedly transmit beacons every 65536 microseconds plus a transmission adjustment. The time period of 65536 microseconds corresponds to a superframe period, while the transmission adjustment provides for small adjustments to the period of the beacons depending on the WUSB host's noticeable drift between received beacons.

A diagram shown in FIG. 2a illustrates a superframe frame structure. A superframe 200 includes a beacon period 205 wherein beacons may be transmitted and a data period 210 wherein data and other transmissions may be transmitted. A diagram shown in FIG. 2b illustrates a first beacon 250 transmitted at time T0 and a second beacon 251 transmitted at time T1. Then a third beacon 255, which may be transmitted by the same WUSB wireless device that transmitted the first beacon 250, may be transmitted at time T0+65536 microseconds+transmission adjustment. Similarly, a fourth beacon 256 may be transmitted at time T1+65536 microseconds+transmission adjustment. The beacon 250 and 255 are transmitted by the same device. The beacons 251 and 256 are transmitted by the same device. Although the discussion focuses on a transmission period of 65536 microseconds+a transmission adjustment, any transmission period with or without transmission adjustment may be utilized. Therefore, the scope and the spirit of the present invention should not be construed as being limited by the examples used herein.

Since the initial transmission time and the transmission adjustment are specified by the host 105 and the scheduling of the transmissions of the beacons are performed by the WUSB wireless device 110, any drift in either the clock of the host 105 or the WUSB wireless device 110 may result in transmission collisions with other beacons or interference to WiMedia transmissions.

However, the host 105 may, on occasion, transmit to the WUSB wireless device 110 a micro-scheduled management command (MMC). An MMC may contain host identifying information, I/O control structures, and time reference to a subsequent MMC. In addition to the host identifying information, the I/O control structures, and the time reference to a subsequent MMC, the MMC may also contain a time stamp indicating the transmission time of the MMC. Since the wireless communications network 100 is a personal area network with an effective radius on the order of a few meters, propagation delay may not be a source of concern. Therefore, when the MMC is transmitted by the host 105 is substantially equal to when the MMC is received by the WUSB wireless device 110. A difference in these times (the MMC transmit time and the MMC receive time) may be due to clock drift between the WUSB host and the WUSB device. The time stamp contained within the MMC may be used to help ensure transmission synchrony between the host 105 and the WUSB wireless device 110.

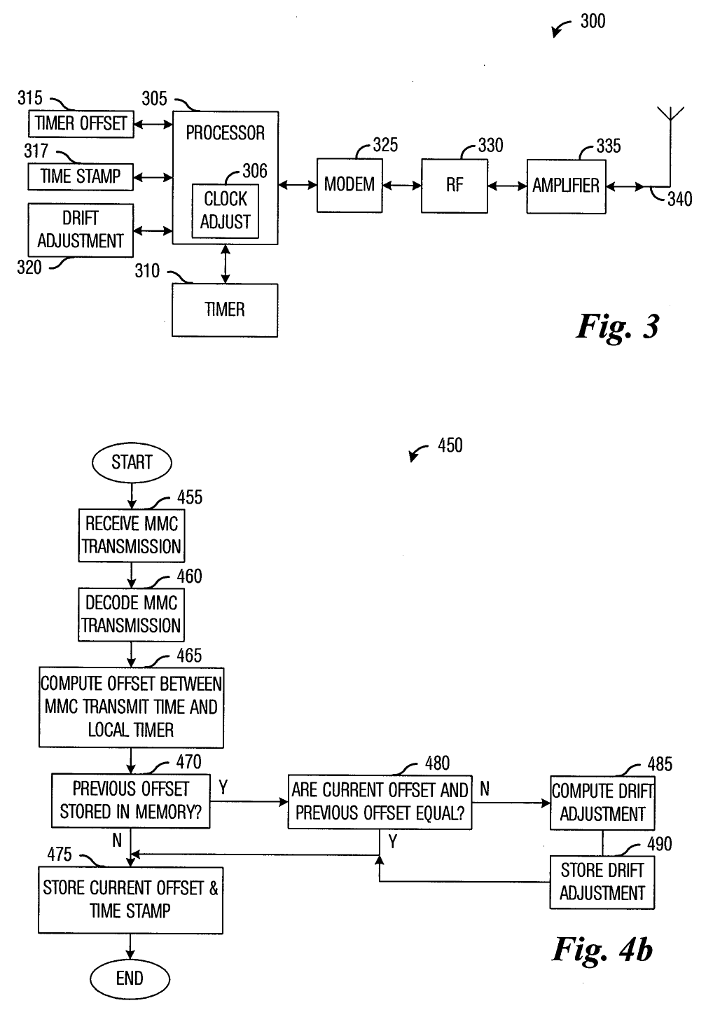

With reference now to FIG. 3, there is shown a diagram illustrating an exemplary wireless device 300. The wireless device 300 may include a controller 305. The controller 305 may be implemented using a microcontroller, a general purpose processing unit, a custom designed integrated circuit, or so on. The controller 305 may be used to provide necessary processing and computing power needed by the wireless device 300. Additionally, the controller 305 may be used to execute programs and applications, control the operation of the wireless device 300, and so forth. Furthermore, the controller 305 may contain a clock adjust unit 306 for use in computing and maintaining adjustments to a clock of the wireless device 300.

The wireless device 300 may also include timer 310 usable for providing timing data to the wireless device 300. The timer 310 may serve as a clock of the wireless device 300 or as a time base for deriving a clock of the wireless device 300. The timer 310 may be free-running timer that may be started at power up of the wireless device 300 and permitted to run without intervention from the other components of the wireless device 300. Also included in the wireless device 300 may be a timer offset storage location 315, a time stamp storage location 317, and drift adjustment storage location 320. The timer offset storage location 315 may be used to store a difference between a time stamp of a received MMC and the value in the timer 310, the time stamp storage location 317 may be used to store the time stamp of the received MMC, and the drift adjustment storage location 320 may be used to store an adjustment to be applied to a scheduled beacon transmission time to compensate for a drift in the timer 310. The timer offset storage location 315, the time stamp storage location 317, and the drift adjustment storage location 320 may be individual storage locations in the wireless device 300, such as dedicated registers, memory cells, or so forth. Alternatively, the timer offset storage location 315, the time stamp storage location 317, and the drift adjustment storage location 320 may be a part of a memory of the wireless device 300.

To communicate wirelessly, the wireless device 300 may include a modem 325, a radio frequency (RF) unit 330, an amplifier unit 335, and an antenna 340. The antenna 340 may receive over-the-air transmissions from other devices and convert the transmissions into electrical signals. The amplifier 335 may be used to increase the signal level of the electrical signals so that they are at a level compatible with electronic circuits in the wireless device 300. The RF unit 330 may take the electrical signals and demodulate data from the electrical signals as well as perform signal processing on the electrical signals and the data, such as filtering, mixing, and so forth. The modem 325 may be responsible for demodulating (decoding) and modulating (encoding) the data based on a communications standard so that the wireless device 300 may communicate with other devices. For example, the modem 325 may demodulate data provided by the RF unit 325 so that the processor 305 may have the data in a form that it may manipulate. A similar, but reversed set of operations may be utilized for data transmitted by the wireless device 300.

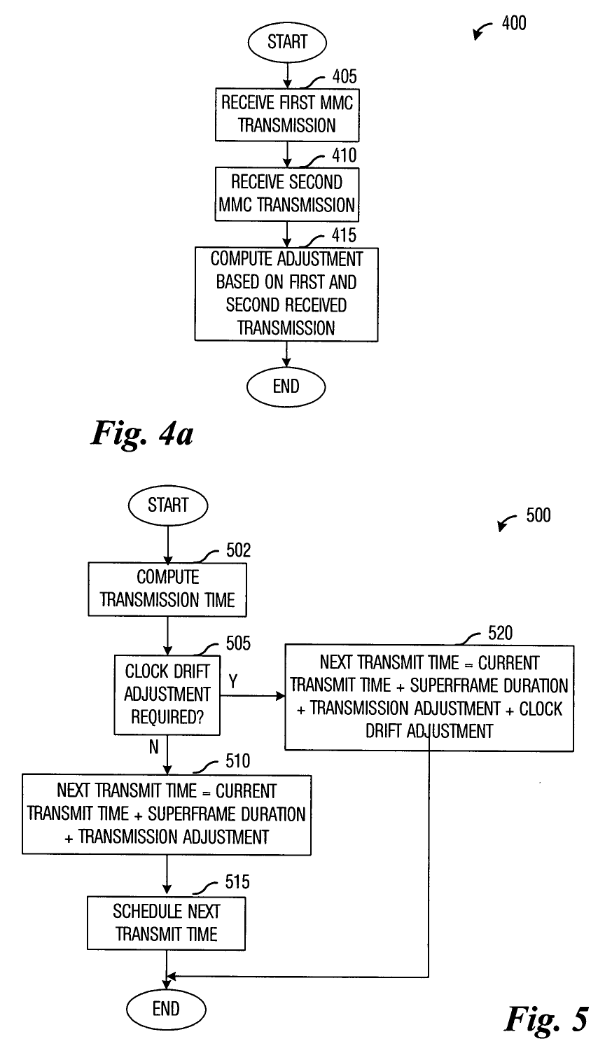

With reference now to FIG. 4a, there is shown a diagram illustrating an algorithm 400 for use in computing a drift adjustment. The algorithm 400 provides a high-level view of the computing of a drift adjustment. The algorithm 400 may execute on a processor, such as the processor 305, of a wireless device, such as the wireless device 300. The algorithm 400 may execute in a dedicated portion of the processor 305, such as the clock adjust unit 306. The algorithm 400 may be configured to execute continuously in the background while the wireless device 300 is in a normal operating mode and may start whenever the wireless device 300 is powered on or after a reset. Alternatively, the algorithm 400 may be executed only when the wireless device 300 receives an MMC transmission.

The computing of a drift adjustment may begin with the receiving of a first MMC transmission from a host, such as the host 105 (block 405). After the first MMC has been received by the wireless device 300, a second MMC transmission from the host 105 may be received (block 410). After the second MMC transmission from the host 105 has been received, the processor 305 may compute an adjustment for any drift that may have occurred in a clock of the wireless device 300, such as the clock 310 (block 415). The adjustment may be based on the first MMC transmission and the second MMC transmission.

With reference now to FIG. 4b, there is shown a diagram illustrating an algorithm 450 for use in computing a drift adjustment. The algorithm 450 may be an implementation of the algorithm 400 of FIG. 4a. The algorithm 450 may execute on a processor, such as the processor 305, of a wireless device, such as the wireless device 300. The algorithm 450 may execute in a dedicated portion of the processor 305, such as the clock adjust unit 306. The algorithm 450 may be configured to execute continuously in the background while the wireless device 300 is in a normal operating mode and may start whenever the wireless device 300 is powered on or after a reset. Alternatively, the algorithm 450 may be executed only when the wireless device 300 receives an MMC transmission.

The computing of a drift adjustment may begin with the receiving of an MMC transmission from a host, such as the host 105 (block 455). After the MMC has been received by the wireless device 300, the processor 305 may begin decoding the MMC (block 460). An item of interest to the processor 305 for the purpose of computing the drift adjustment may be a time stamp carried in the MMC. The time stamp provides information on when the MMC was transmitted by the host 105. Since the host 105 and the wireless device 300 are part of a small wireless communications network, for example, a personal area network (PAN), there should be substantially no measurable lag between the transmission of the MMC by the host 105 and the reception of the MMC by the wireless device 300. Although there may be an actual propagation delay, it may not be measurable by the equipment present in the host 105 or the wireless device 300, i.e., the timers present in either device may not have adequate precision.

After the MMC has been received (block 455) and decoded (block 460), the processor 305 may compute an offset between the MMC transmit time (the time stamp contained in the MMC) and the value in the timer in the wireless device 300, such as the timer 310 (block 465). The processor 305 may use the value in the timer corresponding to when the MMC was received, when the MMC was decoded, when the processor 305 began computing the offset, or so on. The computing of the offset may be expressed as:

MMC transmit time−timer value,

where MMC transmit time is the time stamp contained in the MMC and the timer value is the value of the timer 310.

After computing the offset, the processor 305 may check a timer offset storage location, such as the timer offset storage location 315, to determine if an offset has already been computed and stored (block 470). Since two or more offsets may be needed to compute a drift, if an offset has not already been computed and stored, the processor 305 may store the computed offset in the timer offset storage location 315 and the time stamp of the MMC in a time stamp storage location, such as the time stamp storage location 317 (block 475) and then wait for the arrival of another MMC.

If an offset has already been computed and stored (block 470), then the processor may check to determine if the computed offset that it has just computed (block 465) and the offset stored in the timer offset storage location 315 are substantially equal (block 480). If the computed offset just computed and the offset stored in the timer offset storage location 315 are about equal, then there is no clock drift in the timer 310 of the wireless device 300, compared to the WUSB host 105. Depending on the desired precision, the two offsets must be exactly equal or the two offsets may be deemed to be equal if they differ by a specified number of clock clicks. If the two offsets are determined to be substantially equal, then the processor 305 may store the offset just computed and the time stamp of the MMC used in the computing of the timer offset in the timer offset storage location 315 and the time stamp storage location 317, respectively. Replacing the old values in the timer offset storage location 315 and the time stamp storage location 317 with the newest values can help to provide a more accurate representation of the drift in the timer 310. This may be important since clock drift may vary with temperature, voltage levels, and so forth, conditions that may vary over time.

If the offset just computed and the offset stored in the timer offset storage location 315 differ by more than a specified amount, then the timer 310 of the wireless device 300 has drifted and a drift adjustment may need to be computed (block 485). For example, the drift adjustment may be computed as follows:

drift adjustment=(offset just computed−stored offset)*65536/MMC span,

where offset just computed is the timer offset computed in block 415, stored offset is the timer offset stored in the timer offset storage location 315, and MMC span is a difference in the time stamp of the MMCs used in the computing of the timer offsets.

With the drift adjustment computed in block 485, the drift adjustment may then be stored in a drift adjustment storage location, such as the drift adjustment storage location 320 (block 490). Also stored may be the offset just computed and the time stamp of the MMC used in the computing of the timer offset. Replacing the old values in the timer offset storage location 315 and the time stamp storage location 317 with the newest values can help to provide a more accurate representation of the drift in the timer 310.

With reference now to FIG. 5, there is shown a diagram illustrating an algorithm 500 for use in computing a beacon transmission time. The algorithm 500 may execute on a processor, such as the processor 305, of a wireless device, such as the wireless device 300. The algorithm 500 may be configured to execute continuously in the background while the wireless device 300 is in a normal operating mode and may start whenever the wireless device 300 is powered on or after a reset. Alternatively, the algorithm 500 may be configured to execute whenever the wireless device 300 needs to schedule the transmission of a beacon, for example, after the transmission of a scheduled beacon.

The computing of a beacon transmission time may begin after a transmission of a previously scheduled beacon and may start with the computing of a transmission time for the beacon (block 502). After the transmission time has been computed, then the computing of the beacon transmission may continue with a determination if a drift adjustment is required (block 505). The determination of whether a drift adjustment is required may be as simple as checking a drift adjustment storage location, such as the drift adjustment storage location 320. If a non-zero value is stored in the drift adjustment storage location 320, then drift adjustment may be required. If drift adjustment is not required, then the beacon transmission time may be computed without having to make use of the value stored in the drift adjustment storage location 320 (block 510). For example, the beacon transmission time may be computed as follows:

beacon transmission time=current beacon transmission time+superframe duration+transmission adjustment,

where the current beacon transmission time is the transmission time of a beacon transmitted immediately before the beacon being scheduled, superframe duration is the specified period of the beacon transmissions (for example, 65536 microseconds), and the transmission adjustment is the wireless device specific adjustment as specified by a host.

Depending on the design of the timer 310 of the wireless device 300, there may be a difference in the clock rate of the timer 310 and the actual time values, for example, the beacon period and the transmission adjustment, as specified by the host 105. It may be possible to correct for the difference by multiplying a summation of the beacon period and the transmission adjustment with a clock factor, where the clock factor may be a ratio of the timer 310 to a one (1) MHz reference clock used in the host 105. For example, if the timer 310 is a 100 MHz clock, then clock factor would be 100:1 or 100. The use of the one MHz reference clock and the 100 MHz clock are for discussion purposes only. The reference clock and the clock in the wireless device 300 may be operating at other frequencies. Therefore, the use of the one MHz and 100 MHz clocks should not be construed as being limiting to either the scope or the spirit of the present invention.

With the beacon transmission computed in block 510, the beacon transmission may then be scheduled at the computed beacon transmission time (block 515). If drift adjustment is required, then the beacon transmission may be computed with use of the value stored in the drift adjustment storage location (block 515). For example, the beacon transmission time with drift adjustment may be computed as follows:

beacon transmission time=current beacon transmission time+superframe duration+transmission adjustment+drift adjustment,

where the current beacon transmission time is the transmission time of a beacon transmitted immediately before the beacon being scheduled, superframe duration is the specified period of the beacon transmissions (for example, 65536 microseconds), the transmission adjustment is the wireless device specific adjustment as specified by a host, and the drift adjustment is the value stored in the drift adjustment storage location.

As discussed previously, depending on the design of the timer 310 of the wireless device 300, there may be a difference in the clock rate of the timer 310 and the actual time values, for example, the beacon period and the transmission adjustment, as specified by the host 105. If there is a difference, then the difference may be corrected by multiplying a summation of the beacon period and the transmission adjustment with a clock factor, where the clock factor may be a ratio of the timer 310 to a one (1) MHz reference clock used in the host 105.

With the beacon transmission computed in block 520, the beacon transmission may then be scheduled at the computed beacon transmission time (block 515). The computing of the beacon transmission time may then end until after the scheduled beacon is transmitted, for example.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for determining an adjustment for clock drift, the method comprising:
receiving a first transmission with a first time stamp;
receiving a second transmission with a second time stamp; and
computing the adjustment based on a first receive time of the first transmission and the first time stamp, and a second receive time of the second transmission and the second time stamp.

2. The method of claim 1, further comprising:
after the receiving of the first transmission, computing a first offset between a local clock and the first time stamp; and
after the receiving of the second transmission, computing a second offset between the local clock and the second time stamp.

3. The method of claim 2, wherein the computing comprises computing the adjustment in response to a determining that the first offset and the second offset are not substantially equal.

4. The method of claim 1, wherein a first offset comprises a difference between the first receive time and the first time stamp and the second offset comprises a difference between the second receive time and the second time stamp, and wherein the adjustment comprises a difference between the second offset and the first offset.

5. The method of claim 4, and wherein the adjustment is computed as follows:
adjustment=(second offset−first offset)/packet span,
where packet span comprises a time span between the first time stamp and the second time stamp.

6. The method of claim 5, wherein the packet span comprises a difference of a transmit time of the first transmission and a transmit time of the second transmission.

7. The method of claim 4, wherein the adjustment is used to adjust for a clock with a drift, wherein the clock is used to time a packet transmission every T seconds, and wherein the adjustment is further multiplied by T (a drift rate).

8. A method for transmitting a packet at a scheduled time to a host device, the method comprising:
computing a transmission time for the packet;
adding an adjustment to the transmission time in response to a determining that clock drift has occurred between a local clock and a clock of the host device, wherein the adjustment is based on timing information provided by control instructions transmitted by the host device; and
scheduling the packet for transmission at the transmission time.

9. The method of claim 8, further comprising, prior to the adding, computing the adjustment, wherein the computing of the adjustment comprises:
receiving a first transmission with a first time stamp from the host device;
computing a first difference between the local clock and the first time stamp;
receiving a second transmission with a second time stamp from the host device;
computing a second difference between the local clock and the second time stamp; and
computing the adjustment in response to a determining that the first difference and the second difference differ by more than a specified amount.

10. The method of claim 9, wherein the computing of the adjustment occurs each time a transmission with a time stamp is received after the second transmission is received.

11. The method of claim 8, wherein the computing, the adding, and the scheduling occur after a transmission of a previously scheduled packet.

12. The method of claim 8, wherein the packet is scheduled for transmission after a transmission of a previously scheduled packet, wherein there is a specified amount of time between the transmission of the packet and the previously scheduled packet, and wherein the transmission time is computed as follows:
transmission time=transmission time of previously scheduled packet+specified amount of time.

13. The method of claim 12, wherein there is a multiplicative factor, clock factor, difference between the local clock and a time base of the specified amount of time, and wherein the transmission time is further modified as follows:
transmission time=transmission time of previously scheduled packet+specified amount of time*clock factor.

14. The method of claim 12, wherein the specified amount of time is further modified by an adjustment, and wherein the transmission time is further modified as follows:
transmission time=transmission time of previously scheduled packet+(specified amount of time+adjustment)*clock factor.

15. A device comprising:
an amplifier coupled to an antenna, the amplifier configured to alter a signal level of a signal received by the antenna;
a radio frequency (RF) circuit coupled to the amplifier, the RF circuit configured to extract an analog signal from a carrier signal and to convert the analog signal into a digital data stream;
a modem coupled to the RF circuit, the modem configured to demodulate data received by the device;
a clock to provide a timing base for the device; and
a controller configured to regulate the operation of the device and to perform computations, the controller comprising a clock adjustment unit configured to compute an adjustment for the clock based on timing information received in sequentially received control transmissions.

16. The device of claim 15, further comprising a drift adjustment storage coupled to the controller, the drift adjustment storage to store the adjustment for the clock computed by the clock adjustment unit.

17. The device of claim 15, further comprising:
a timer offset storage coupled to the controller, the timer offset storage to store a timer offset for a most recently received control transmission, wherein the timer offset comprises a difference between the timing information contained in the most recently received control transmission and timing information provided by the clock; and
a time stamp storage coupled the controller, the timer offset storage to store the timing information contained in the most recently received control transmission.

18. The device of claim 15, wherein the device transmits using a Wireless Universal Serial Bus communications protocol.

19. The device of claim 18, wherein the device operates in a multi-communications protocol wireless communications network, and wherein a communications protocol of the wireless communications network comprises the WiMedia communications protocol.

20. The device of claim 18, wherein the control transmission comprises a microscheduled management command (MMC).
